(19) United States
(12) Patent Application Publication
(10) Pub. No.: US 2024/0060526 A1
(43) Pub. Date: Feb. 22, 2024

(54) RETENTION SYSTEM FOR SEPARATOR ELEMENT

(71) Applicant: CECO Environmental IP Inc., Dallas, TX (US)

(72) Inventors: William Roy McDoniel, Porter, TX (US); Carl William Hahn, Houston, TX (US); David Michael Seeger, Spring, TX (US); Mathews Joshua Thundyil, Spring, TX (US)

(73) Assignee: CECO Environmental IP Inc., Dallas, TX (US)

(21) Appl. No.: 18/234,748

(22) Filed: Aug. 16, 2023

Related U.S. Application Data
(60) Provisional application No. 63/398,306, filed on Aug. 16, 2022.

(51) Int. Cl. F16B 37/14

(52) U.S. Cl. CPC F16B 37/14

(57) ABSTRACT

A retention nut for securing a separator element is described herein. The retention nut includes a first portion of the retention nut that includes a threaded cavity to enable coupling of the retention nut to a structural member attached to the separator element, wherein the first portion of the retention nut comprises a means for providing a positive seal between the retention nut and the separator element, and a second portion of the retention nut that includes a feature that is couplable to a retention nut tool using a mechanical force such that a torque applied to the retention nut tool is sufficiently transmitted to the retention nut to one of: tighten the retention nut onto the structural element and loosen the retention nut from the structural element.

### CROSS-REFERENCE TO RELATED APPLICATIONS

This application claims priority to U.S. Provisional Patent Application No. 63/398,306 filed 16 Aug. 2022, titled “RETENTION SYSTEM” which is incorporated by reference herein in its entirety.

### TECHNICAL FIELD

Embodiments relate generally to fasteners, and specifically to a retention system for separator elements such as filters and coalescers.

### BACKGROUND

Cartridge separators are used in the gas and liquid processing industry to remove particulate and liquid contaminants from gas and liquid streams. These cartridges can be located within pressure vessels behind the plane of entry. Since breaking the plane of entry requires a confined space entry permit, a means to secure the cartridges in place without breaking the plane of the vessel is desirable.

### SUMMARY OF THE INVENTION

Separator elements are used in the gas and liquid processing industry to remove particulate and liquid contaminants from gas and liquid streams. One general aspect includes a retention nut for securing a separator element. The retention nut also includes a boss that includes a threaded cavity configured to be threaded over a threaded member of a support structure of the separator element; and a cap attached to the boss, where the cap includes a cavity for at least a portion of its length, and where the cap is grippable by a retention nut tool such that a torque applied to the cap is transmitted to the boss.

Implementations may include one or more of the following features. The retention nut where the cap has a circular cross-section and is finished with a smooth surface. The cavity of the cap has a first inner diameter that is larger than a second inner diameter of the threaded cavity. The boss includes a groove capable of seating an elastomeric sealing element that provides a positive seal between the retention nut and the separator element. The groove is provided at a face of the boss. The groove is provided at an outer surface of the boss. The cap is manufactured from a magnetic material. The cap is manufactured from carbon steel. The cap is grippable by the retention nut tool using a mechanical force applied when the retention nut tool is placed over the cap, and where the cap includes a feature capable of transmitting a torque provided by a turn of the retention nut tool to the boss.

One general aspect includes a retention nut for securing a separator element. The retention nut also includes a first portion of the retention nut that includes a threaded cavity to enable coupling of the retention nut to a threaded portion of a structural element attached to the separator element, where the first portion of the retention nut may include a means for providing a positive seal between the retention nut and the separator element; and a second portion of the retention nut that includes a feature that is couplable to a retention nut tool using a mechanical force such that a torque applied to the retention nut tool is sufficiently transmitted to the retention nut to one of: tighten the retention nut onto a threaded portion of the structural element and loosen the retention nut from the structural element.

Implementations may include one or more of the following features. The retention nut where the first portion is a boss and the second portion is a cap. The first portion and the second portion are manufactured from different materials. The first portion and the second portion are manufactured from the same material. The first portion is manufactured from a first material and the second portion is manufactured from a second material, and where the retention nut may include the first portion and the second portion connected by a welded joint. The second portion of the retention nut tool is grippable by the retention nut tool based on a compressive force provided by a plurality of O-rings provided within an inner surface of the retention nut tool. The second portion of the retention nut tool is grippable by the retention nut tool based on a magnetic force exerted when the retention nut tool is secured around the second portion. The positive seal between the retention nut and the separator element is provided by an elastomeric surface that is placed within a groove provided on a surface of the second portion.

One general aspect includes a method for removably securing a retention nut to a separator element. The method also includes providing the separator element. The method also includes providing the retention nut, where the retention nut includes a boss portion and a cap portion. The method also includes lowering the retention nut using a retention nut tool that is attached by a mechanical force to the cap portion of the retention nut up to a threaded portion of the separator element. The method also includes applying a torque to the retention nut tool, where applying the torque to the retention nut tool causes rotation of the retention nut around the threaded portion of the separator element.

Implementations may include one or more of the following features. The method where the mechanical force is a compressive force exerted by a plurality of O-rings provided within the retention nut tool. Applying the torque to the retention nut tool may include applying a torque to a feature provided on the retention nut tool.

### BRIEF DESCRIPTION OF THE DRAWINGS

FIG. 1 is an isometric view of a retention nut, in accordance with some embodiments.

FIG. 2 is a view of an example separator element secured by a retention nut, in accordance with some embodiments.

FIGS. 3A-3D depict multiple views of an example separator element secured by a retention nut, in accordance with some embodiments.

FIG. 4 is a view of an example separator element secured by a retention nut, in accordance with some embodiments.

FIG. 5 is an isometric view of a retention nut, in accordance with some embodiments.

FIG. 6 is an isometric view of a retention nut, in accordance with some embodiments.

FIG. 7 is an isometric view of a retention nut, in accordance with some embodiments.

FIG. 8 is a section view of a retention nut, in accordance with some embodiments.

FIG. 9 is a section view of a retention nut, in accordance with some embodiments.

FIG. 10 is a section view of a retention nut and a secured separator element, in accordance with some embodiments.

FIG. 11 is a section view of a retention nut, a retention nut removal tool, and a secured separator element, in accordance with some embodiments.

FIGS. 12A-12E depict standard views of a retention nut, in accordance with some embodiments.

FIG. 13 is an isometric view of a retention nut, in accordance with some embodiments.

FIG. 14 is a view of an example separator element secured by a retention nut, in accordance with some embodiments.

FIG. 15 is a view of an example separator element secured by a retention nut, in accordance with some embodiments.

FIGS. 16A-16D depict multiple views of an example separator element secured by a retention nut, in accordance with some embodiments.

FIGS. 17A-17D depict multiple views of an example separator element secured by a retention nut, in accordance with some embodiments.

FIG. 18 is a view of an example separator element secured by a retention nut, in accordance with some embodiments.

FIG. 19 is an isometric view of a retention nut, in accordance with some embodiments.

FIG. 20 is a section view of a retention nut and a secured separator element, in accordance with some embodiments.

FIG. 21 is a section view of a retention nut, a retention nut removal tool, and a secured separator element, in accordance with some embodiments.

FIGS. 22A-22E depict standard views of a retention nut, in accordance with some embodiments.

FIG. 23 is a section view of a retention nut, in accordance with some embodiments.

FIGS. 24A-24D depict views of an example retention nut tool, in accordance with some embodiments.

FIG. 25 depicts an example method to secure a separator element, in accordance with some embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some embodiments”, “an embodiment”, “an example embodiment”, etc., indicate that the embodiment described may include a particular feature, structure, or characteristic, but every embodiment may not necessarily include the particular feature, structure, or characteristic. Similarly, references in the specification to “some implementations”, “an implementation”, “an example implementation”, etc., indicate that the implementation described may include a particular feature, structure, or characteristic, but every implementation may not necessarily include the particular feature, structure, or characteristic. Moreover, such phrases do not necessarily referring to the same embodiment or implementation. Further, when a particular feature, structure, or characteristic is described in connection with an embodiment, such feature, structure, or characteristic may be implemented in connection with other embodiments whether or not explicitly described.

Cartridge separators are used in the gas and liquid processing industry to remove particulate and liquid contaminants from gas and liquid streams. These cartridges can be located within pressure vessels behind the plane of entry. Since breaking the plane of entry requires a confined space entry permit, developing a means to secure the cartridges in place without breaking the plane of the vessel is desired. Finally, there is a need to ensure that these retention devices can be safely retrieved from the vessel even if they are inadvertently dropped in it.

Per techniques of this disclosure, a retention nut and corresponding retention nut tool are described that enable the securing of a separator element. The retention nut provides a seal to prevent or limit fluid flow from the inside of the separator element, e.g., cartridge to the outside, through the sealing end cap, thus forcing the fluid through the separation media. The design allows for the use of end caps that have their own seals, or for end caps that have no seals and seal on the retention mechanism.

A retention device is described herein that has an integral seal and a feature that permits the use of a retention device tool that can be used to safely and securely introduce and retrieve the retention device.

A retention device is utilized to secure the separator element, e.g., a filter element or a coalescing element. The retention system includes a threaded boss. The threaded boss may be manufactured from an austenitic stainless steel such as 304L for added corrosion resistance. A carbon steel cap enables retrieval of the device by a magnet. O-ring(s) may be provided to create a positive seal.

The retention system enables a separator element to be coupled to a riser. A retention nut tool can be utilized to secure and remove the retention system. The retention nut tool includes O-rings that secure the nut extended during operation.

The nut includes a face sealing O-ring or gasket that seals either on the endcap, or on an elastomer that has been affixed to the endcap. The nut extender tool includes an external feature, (preferably a hex that allows for a socket wrench) to apply suitable torque to the nut and enables the nut to be torqued from a distance. A length of the tool may be adjusted based on a particular application of intended use. The feature also enables magnetic retrieval from a pressure vessel.

The nut can be combined with a removal tool, where the hold down tool “grabs” the nut by means of O-ring compression, allowing the tool to maneuver the nut in an intended direction by a significant distance before engaging the threaded rod or bolt.

The extender tool is designed such that its handle can be about 14 inches above the top of a pressure vessel opening where the nut is deployed. The extender tool is provided with a hex feature that can accept a torque wrench with socket for tightening and loosening the retention nut.

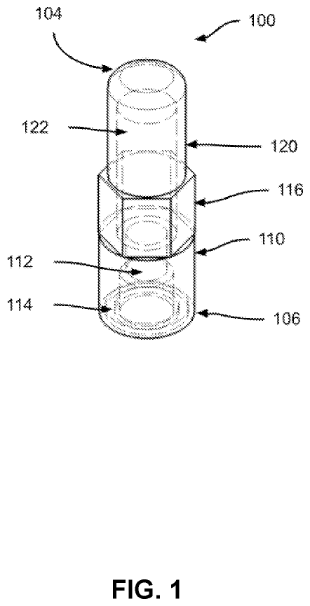

FIG. 1 is an isometric view of a retention nut, in accordance with some embodiments.

As depicted in FIG. 1, retention nut 100 comprises a boss 110 and a cap 120. Boss 110 includes a threaded cavity 112 that extends through the boss. A groove 114 may be provided at a bottom face (face) 106 of the boss, as shown. In some embodiments, the groove may be provided around an outer surface of the boss. The cap 120 includes a cavity 122 that extends for at least a portion of the cap. The cavity of the cap has a first inner diameter that is larger than a second inner diameter of the threaded cavity. The cavity in the cap may enable the retention nut to be utilized with threaded bolts and/or rods of various different lengths.

Cap 120 is designed such that it may be gripped by an external tool, e.g., a retention nut tool. Cap 120 includes a feature 116, e.g., a polygonal feature, provided on an outer surface, that can advantageously receive and transmit a torsional force to boss 110 when an external tool is rotated around the cap. In some embodiments, the polygonal feature is a hexagonal feature that is provided on the outer surface of the cap.

In some embodiments, the cap has a circular cross-section and is finished with a smooth surface. In some embodiments, the cap may include markings on an outer surface that may enable gripping by a suitable retention nut tool. For example, the cap may include a surface that is cut in a spline engageable by a corresponding spline provided on a retention nut tool

The cap mitigates a possibility of gas or liquid bypass through the threads of the threaded coupling between the retention nut and the separator element. Additionally, the added height of the retention nut enables easier location of the threaded element when access is attempted from outside the pressure vessel.

In some embodiments, the cap has a circular cross section for a portion of its extent, and a hexagonal cross section of its extent. For example, in some embodiments, about a third of the length of the cap may have a hexagonal cross section and about two-thirds of the length of the cap may have a circular cross section.

In some embodiments, the boss and the type of seal employed may be based on the size and shape of a closed endcap, e.g., of a separator element. The size and shape of the cap may be based on a preferred method of application of torque, the specific application (industry), and cost factors.

In some embodiments, the cap is grippable by a retention nut tool using a mechanical force applied when the retention nut tool is placed over the cap, and the cap further includes a feature capable of transmitting a torque provided by a turn of the retention nut tool to the boss.

In some embodiments, the feature may be a hexagonal feature on the sides of the cap. In some other embodiments, the feature may be provided at a top face of the cap, e.g., a screw head provided at the top of the cap that can engage with a retention nut tool and enable the retention nut to be suitably torqued.

In some embodiments, the cap may include a threaded portion of the cavity.

The boss 120 includes a groove capable of seating an elastomeric sealing element that provides a positive seal between the retention nut and the separator element. In some embodiments, the elastomeric sealing element may be a face sealing O-ring or gasket that can provide a positive seal between the retention nut and a separator element. In other embodiments, another type of O-ring, gasket, piston seal, chevron, or any type of seal made of any kind of elastomeric material may be utilized to provide the positive seal.

In some implementations, the groove 114 may be provided on an outer surface of the boss, or within the boss. The threaded cavity of the boss is configured to be threaded over a threaded member, e.g., riser, bolt, etc., of a support structure (structural support element or member) of a separator element.

In some embodiments, the boss may be manufactured from a corrosion resistant material, e.g., 304L stainless steel, and the cap may be manufactured from carbon steel. In some embodiments, the boss and the cap may be manufactured from a material that is corrosion resistant as well as magnetic, e.g., series 400 steel.

In some embodiments, the boss and cap are manufactured (machined) separately, and coupled by a welded joint.

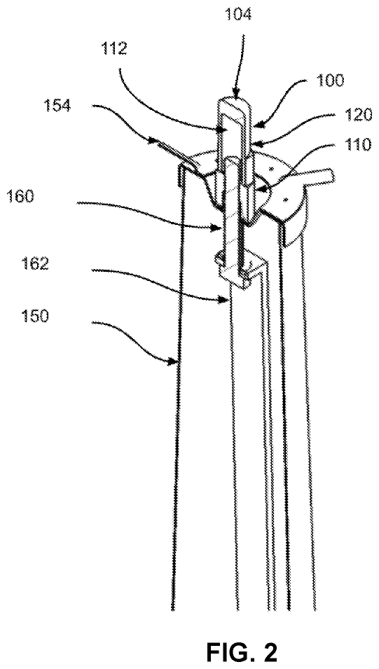

FIG. 2 is a view of an example separator element secured by a retention nut, in accordance with some embodiments.

As depicted in FIG. 2, retention nut 100 can be utilized to removably secure a separator element 150, e.g., a filter or coalescer cartridge. The retention nut can be threaded over a threaded member 160 of a support element 162 of separator element 150. A retention nut tool (not depicted in FIG. 2) may be utilized to lower the retention nut from outside a pressure vessel or other chamber until contact is made with the threaded member 160. Rotation of the retention nut tool causes the threaded portion of the boss to rotate around the threaded member 160 until a desired tightness is achieved.

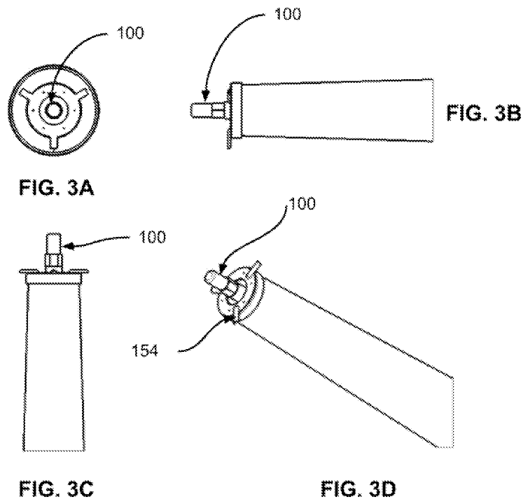

FIGS. 3A-3D depicts multiple views of an example separator element secured by a retention nut, in accordance with some embodiments.

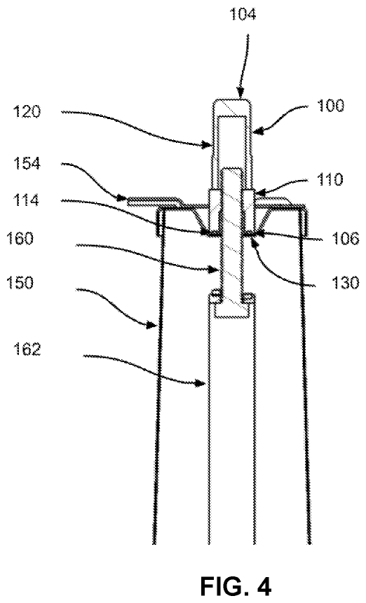

FIG. 4 is a view of an example separator element secured by a retention nut, in accordance with some embodiments.

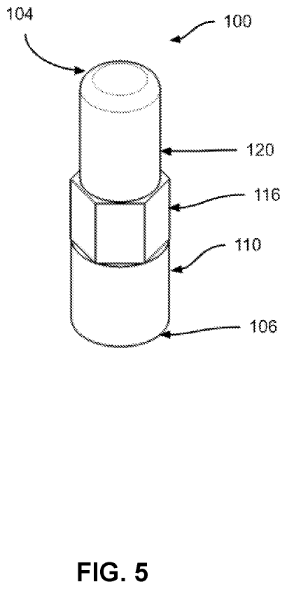

FIG. 5 is an isometric view of a retention nut, in accordance with some embodiments.

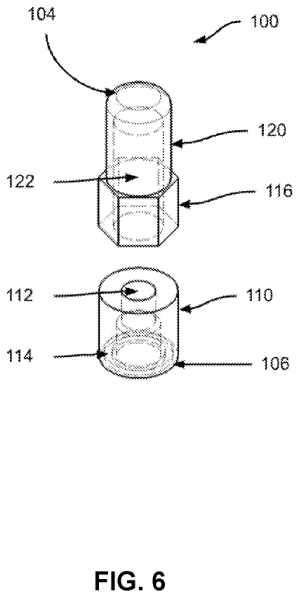

FIG. 6 is an isometric view of a retention nut, in accordance with some embodiments.

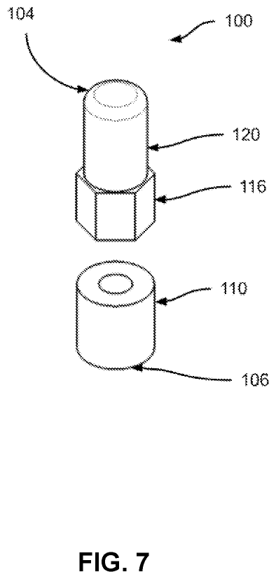

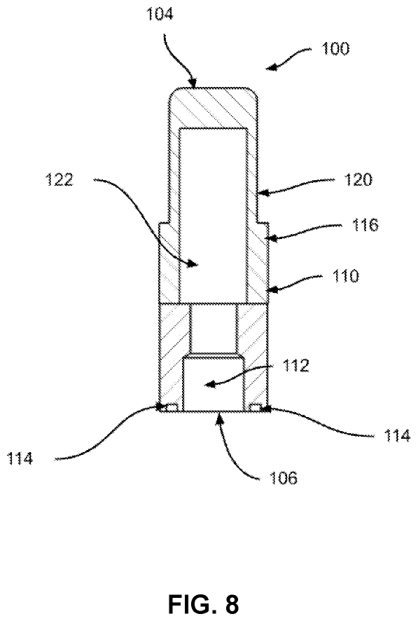

FIG. 7 is an isometric view of a retention nut, in accordance with some embodiments. FIG. 8 is a section view of a retention nut, in accordance with some embodiments.

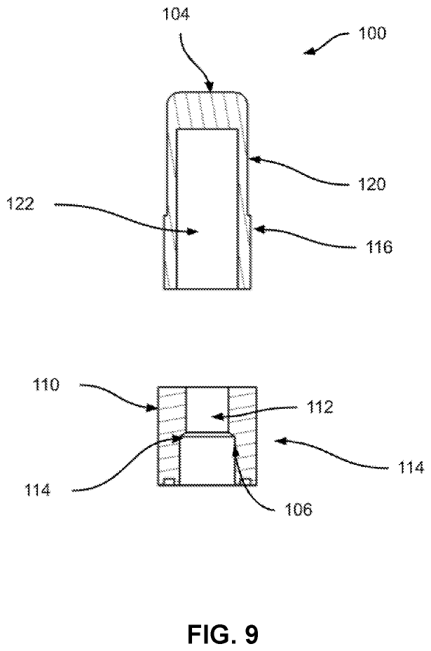

FIG. 9 is a section view of a retention nut, in accordance with some embodiments.

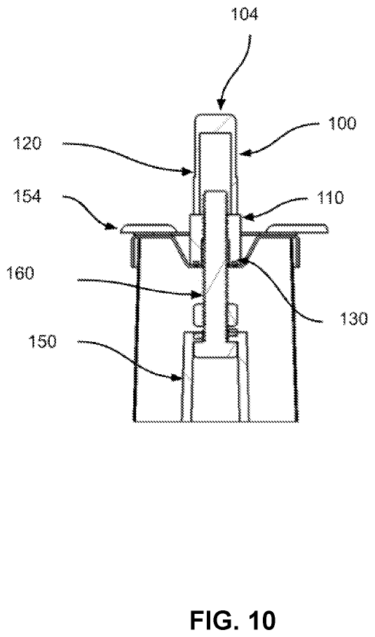

FIG. 10 is a section view of a retention nut and a secured separator element, in accordance with some embodiments.

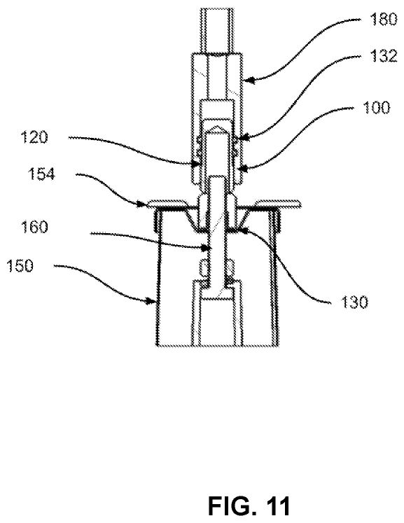

FIG. 11 is a section view of a retention nut, a retention nut removal tool, and a secured separator element, in accordance with some embodiments.

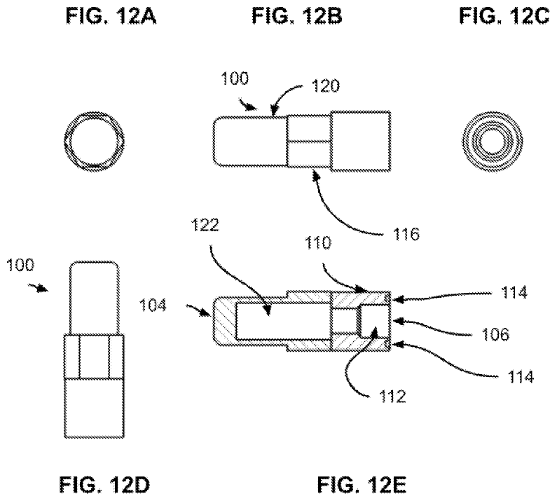

FIGS. 12A-12E depicts standard views of a retention nut, in accordance with some embodiments.

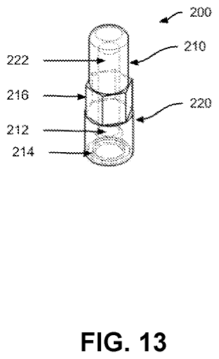

FIG. 13 is an isometric view of a retention nut, in accordance with some embodiments.

As depicted in FIG. 13, retention nut 200 includes a first portion 220 of the retention nut that includes a threaded cavity 212 to enable coupling of the retention nut 200 to a structural member attached to the separator element. The first portion of the retention nut comprises a means for providing a positive seal between the retention nut and the separator element. In some embodiments, the means for providing the positive seal is provided at a face, e.g., a bottom face of the first portion.

In some embodiments, the means for providing the positive seal may include a groove capable of seating an elastomeric sealing element that provides a positive seal between the retention nut and the separator element. In some embodiments, the means for providing the positive seal may include a face sealing O-ring or gasket that can provide a positive seal between the retention nut and a separator element.

In other embodiments, another type of O-ring, gasket, chevron, piston seal, face seal, rod seal, or any other type of seal made of any kind of elastomeric material may be utilized to provide the positive seal. In some embodiments, the means for providing a positive seal may include other types of seals, e.g., a spiral wound gasket, a metal—to metal seal, a ring seal, a composite gasket (graphite, asbestos, etc.), a metal gasket, Teflon gasket, etc.

In some embodiments, the positive seal between the retention nut and the separator element is provided by an elastomeric surface that is placed within a groove provided on a surface of the second portion. In some embodiments, the groove may be provided on a bottom face of the first portion of the retention nut. In some embodiments, the groove may be provided on an outside surface (e.g., around a circumference) of the first portion of the retention nut.

The retention nut includes a second portion 210 of the retention nut that includes a feature 216 that is couplable to (e.g., grippable by) a retention nut tool using a mechanical force such that a torque applied to the retention nut tool is sufficiently transmitted to the retention nut to perform an operation of tightening the retention nut onto the structural element or to loosen the retention nut from the structural element. For example, the retention nut may be tightened onto a riser or other support element attached to the separator. In some embodiments, the torque may be applied from a distance, e.g., by rotating a retention nut tool from outside a pressure vessel or other chamber within which the separator element is positioned.

In some embodiments, the mechanical force may be provided by utilizing a plurality of O-rings that provide a compressive force when secured (e.g., placed in a tight fit) over the second portion of the retention nut. In some embodiments, the mechanical force may be a magnetic force provided when the retention tool is secured over the second portion of the retention nut.

In some other embodiments, one of the cap or boss may include a spring-loaded ball and the tool may be designed to include detent to accept the ball. In some embodiments, a keyhole connection may be provided which can be engaged with a headed pin. In some embodiments, the cap may include an external thread that a suitable tool can interface with. In some embodiments, slots, tabs, adhesives, threaded connection, etc., may be utilized to enable attachment.

In some implementations, the mechanical force may be provided by a spring-loaded ball bearing provided in the retention nut tool, which can engage with a detent provided on the cap or boss.

The second portion 210 includes a cavity for at least a portion of its extent that may enable the retention nut to be compatible with different lengths of threaded rods or bolts that are utilized to engage the retention nut.

In some embodiments, a cavity in the second portion has the same inner diameter as the cavity in the first portion. In some implementations, the cavity in the second portion may include a partially or wholly threaded section.

In some embodiments, the first portion and the second portion may be machined (manufactured) from the same material and as a single piece. In some other embodiments, the first portion may be manufactured from a first material and the second portion may be manufactured from a second material, and the retention nut may include the first portion and the second portion connected by a welded joint.

In some embodiments, the first and second portions may be manufactured from series 400 stainless steel. In some other embodiments, the first portion and the second portion are manufactured from different materials. For example, the first portion may be manufactured from a corrosion resistant material, e.g., 304L stainless steel, and the second portion may be manufactured from a magnetic material, e.g., carbon steel.

In some embodiments, the retention nut may be manufactured from non-metallic materials. For example, a polymeric retention nut, a ceramic retention nut, or a composite retention nut may be utilized in applications where metal might not be preferred.

In some embodiments, the first portion may be a boss and the second portion may be a cap.

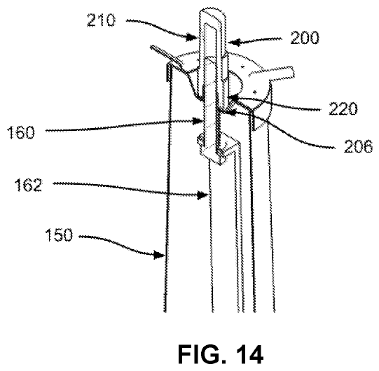

FIG. 14 is a view of an example separator element secured by a retention nut, in accordance with some embodiments.

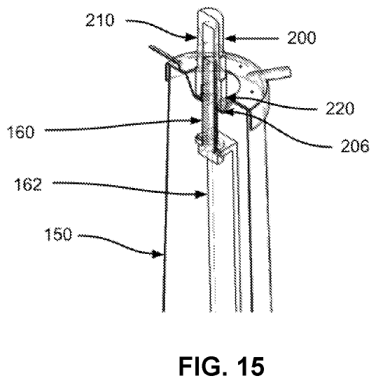

FIG. 15 is a view of an example separator element secured by a retention nut, in accordance with some embodiments.

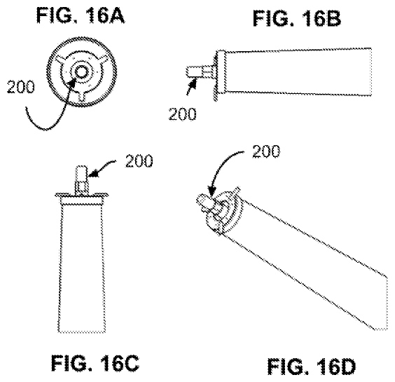

FIGS. 16A-16D depicts multiple views of an example separator element secured by a retention nut, in accordance with some embodiments.

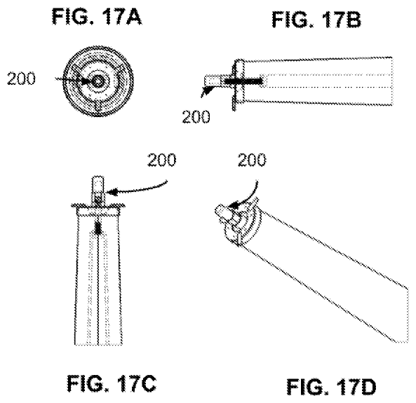

FIG. 17A-17D depicts multiple views of an example separator element secured by a retention nut, in accordance with some embodiments.

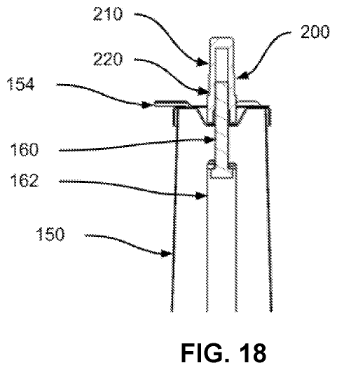

FIG. 18 is a view of an example separator element secured by a retention nut, in accordance with some embodiments.

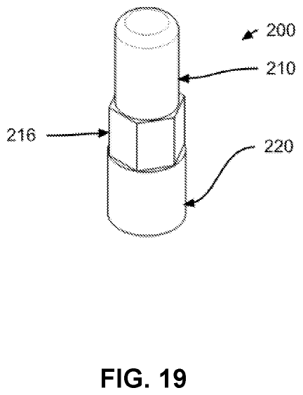

FIG. 19 is an isometric view of a retention nut, in accordance with some embodiments.

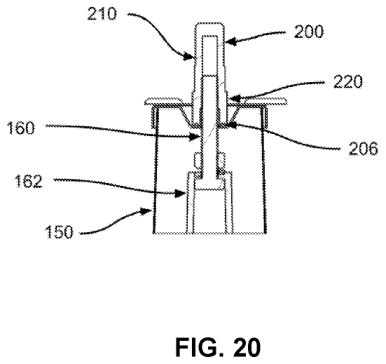

FIG. 20 is a section view of a retention nut and a secured separator element, in accordance with some embodiments.

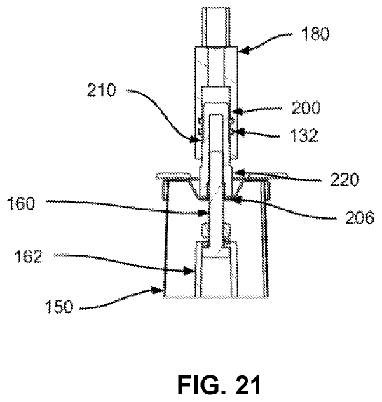

FIG. 21 is a section view of a retention nut, a retention nut removal tool, and a secured separator element, in accordance with some embodiments.

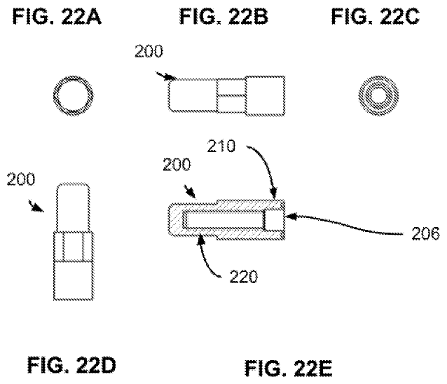

FIG. 22 depicts standard views of a retention nut, in accordance with some embodiments.

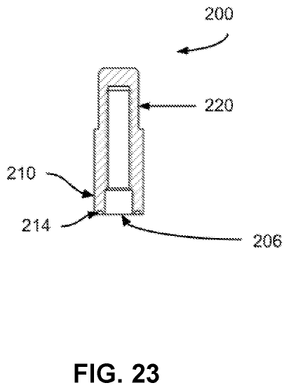

FIG. 23 is a section view of a retention nut, in accordance with some embodiments.

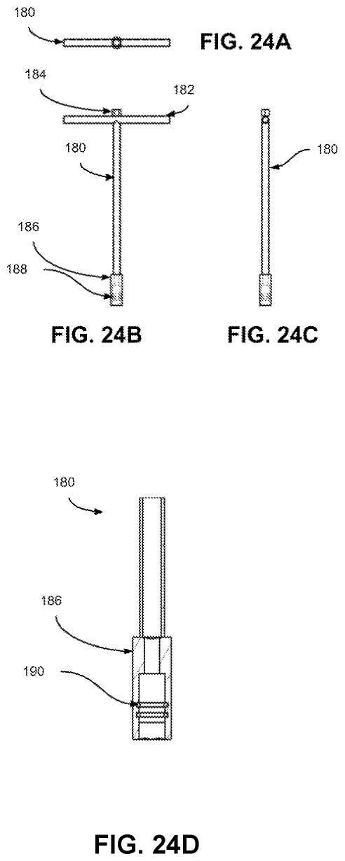

FIG. 24A-D depicts an example retention nut tool, in accordance with some embodiments.

As depicted in FIGS. 24A-D, the retention nut tool 180 includes a suitable feature 184, e.g., a polygonal feature that can accept a wrench such that a torque applied when engaged is transmitted along a shaft of the retention nut tool.

The retention nut tool additionally includes a pocket or receptacle 186 that can be utilized to grip a retention nut, and is sized suitable to tightly grip the retention nut. For example, the retention nut tool may include a suitable cavity or recess that enables it to be placed in a position such that it may grip a retention nut, and enable movement of the retention nut. The retention nut tool also includes a feature 188, e.g., a polygonal or hexagonal feature such as a socket, that can transmit an applied torque to a retention nut being gripped and apply sufficient torque to tighten the nut onto a threaded element, e.g., a riser or other element/coalescer support.

FIG. 24B depicts an example retention nut tool, in accordance with some embodiments.

The retention nut tool includes a feature that enables it to grip a retention nut. The grip may be based on a mechanical or other force. For example, the grip may be based on a compressive force provided by a plurality of O-rings 190 provided within an inner surface of the retention nut tool. In some embodiments, the grip may be based on a magnetic force, e.g., exerted between the retention nut tool and the retention nut. The retention nut tool may also be utilized to pick up and retrieve the retention nut in the event that the retention nut falls inside the pressure vessel during operation.

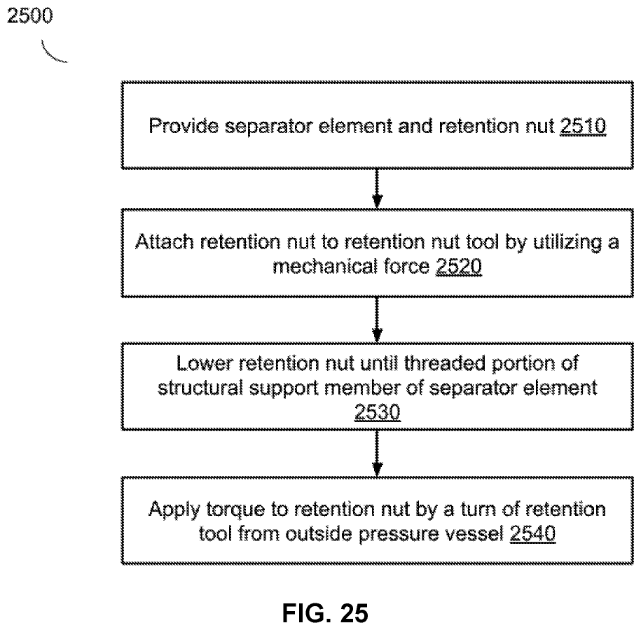

FIG. 25 depicts an example method to secure a separator element, in accordance with some embodiments.

As depicted in FIG. 25, method 2500 to removably secure a retention nut to a separator element includes providing (2510) the separator element and retention nut, wherein the retention nut includes a boss portion and a cap portion, and the separator element includes a structural support element, e.g., a threaded rod or bolt that can threadably engage with the retention nut.

A retention nut tool is attached (2520) by a mechanical force to a portion (cap portion or second portion) of the retention nut, e.g., by gripping the retention nut with the retention nut tool.

The retention nut is lowered (2530) in the gripped state by the retention nut tool up to a threaded portion of a structural support element of the separator element.

A torque is applied (2540) to the retention nut tool, e.g., by turning a feature provided on the retention nut tool, that causes rotation of the retention nut around the threaded portion of a structural support element of the separator element.

In some embodiments, the mechanical force is a compressive force exerted by a plurality of O-rings provided within the retention nut tool. In some other embodiments, the mechanical force is a magnetic force exerted by the retention nut tool.

In some embodiments, a retention system to secure a separator element in a pressure vessel may be utilized wherein the retention system includes a retention nut that includes a boss portion and a cap portion as well as a retention nut tool that can be attached to the cap portion of the retention nut by means of a mechanical force. In some embodiments, the retention system may further include a robotic arm that is configured to lower and raise the retention nut and tighten and loosen the retention nut suitably.

It should be understood that the individual elements or elements described above may be applicable to additional structures of different types than those described above. Furthermore, it is easy for those skilled in the art to apply various items that characterize elements in the present disclosure in view of the prior art.

What is claimed is:

1. A retention nut to secure a separator element, comprising:
a boss that includes a threaded cavity configured to be threaded over a threaded member of a support structure of the separator element; and
a cap attached to the boss, wherein the cap includes a cavity for at least a portion of its length, and wherein the cap is grippable by a retention nut tool such that a torque applied to the cap is transmitted to the boss.

2. The retention nut of claim 1, wherein the cap has a circular cross-section and is finished with a smooth surface.

3. The retention nut of claim 1, wherein the cavity of the cap has a first inner diameter that is larger than a second inner diameter of the threaded cavity.

4. The retention nut of claim 1, wherein the boss includes a groove capable of seating an elastomeric sealing element that provides a positive seal between the retention nut and the separator element.

5. The retention nut of claim 4, wherein the groove is provided at a face of the boss.

6. The retention nut of claim 4, wherein the groove is provided at an outer surface of the boss.

7. The retention nut of claim 1, wherein the cap is manufactured from a magnetic material.

8. The retention nut of claim 7, wherein the cap is manufactured from carbon steel.

9. The retention nut of claim 1, wherein the cap is grippable by the retention nut tool using a mechanical force applied when the retention nut tool is placed over the cap, and wherein the cap includes a feature capable of transmitting a torque provided by a turn of the retention nut tool to the boss.

10. A retention nut to secure a separator element, comprising:
a first portion of the retention nut that includes a threaded cavity to enable coupling of the retention nut to a structural element attached to the separator element, wherein the first portion of the retention nut comprises a means for providing a positive seal between the retention nut and the separator element; and
a second portion of the retention nut that includes a feature that is couplable to a retention nut tool using a mechanical force such that a torque applied to the retention nut tool is sufficiently transmitted to the retention nut to one of: tighten the retention nut onto the structural element and loosen the retention nut from the structural element.

11. The retention nut of claim 10, wherein the first portion is a boss and the second portion is a cap.

12. The retention nut of claim 10, wherein the first portion and the second portion are manufactured from different materials.

13. The retention nut of claim 10, wherein the first portion and the second portion are manufactured from the same material.

14. The retention nut of claim 10, wherein the first portion is manufactured from a first material and the second portion is manufactured from a second material, and wherein the retention nut comprises the first portion and the second portion connected by a welded joint.

15. The retention nut of claim 10, wherein the second portion of the retention nut tool is grippable by the retention nut tool based on a compressive force provided by a plurality of O-rings provided within an inner surface of the retention nut tool.

16. The retention nut of claim 10, wherein the second portion of the retention nut tool is grippable by the retention nut tool based on a magnetic force exerted when the retention nut tool is secured around the second portion.

17. The retention nut of claim 10, wherein the positive seal between the retention nut and the separator element is provided by an elastomeric surface that is placed within a groove provided on a surface of the second portion.

18. A method for removably securing a retention nut to a separator element, the method comprising:
providing the separator element;
providing the retention nut, wherein the retention nut includes a boss portion and a cap portion;
lowering the retention nut using a retention nut tool that is attached by a mechanical force to the cap portion of the retention nut up to a threaded portion of the separator element; and
applying, a torque to the retention nut tool, wherein applying the torque to the retention nut tool causes rotation of the retention nut around the threaded portion of the separator element.

19. The method of claim 18, wherein the mechanical force is a compressive force exerted by a plurality of O-rings provided within the retention nut tool.

20. The method of claim 18, wherein applying the torque to the retention nut tool comprises applying a torque to a feature provided on the retention nut tool.
